(19) United States
(12) Patent Application Publication
(10) Pub. No.: US 2018/0189816 A1
(43) Pub. Date: Jul. 5, 2018

(54) Method for Networking Users for Submission and Processing of Referrals

(71) Applicant: Daniel Lee DeVore, Los Angeles, CA (US)

(72) Inventor: Daniel Lee DeVore, Los Angeles, CA (US)

(21) Appl. No.: 15/860,488

(22) Filed: Jan. 2, 2018

Related U.S. Application Data
(60) Provisional application No. 62/440,721, filed on Dec. 30, 2016.

(51) Int. Cl. G06Q 30/02

(52) U.S. Cl. CPC G06Q 30/0214; H04L 67/10

(57) ABSTRACT

A method for method for networking users for submission and processing of referrals uses multiple user accounts and a remote server. Each user account is associated to a user PC device. Additionally, the method differentiates business user accounts from gen personal user accounts. Each business account is associated with a service identifier that denotes what services the business account can provide. To begin, the user submits raw referral data. The raw data is then analyzed to determine who the referralee is and the type of service that the referralee desires. Once this analysis is complete, the raw data is formatted and then routed to the business accounts that are capable of providing the desired service. The business account arranges a service contract with the referralee and the user who submitted the referral is provided with some form of compensation.

The current application claims a priority to the U.S. Provisional Patent application Ser. No. 62/404,721 filed on Dec. 30, 2016.

### FIELD OF THE INVENTION

The present invention relates generally to a method for sending and receiving referrals. More specifically, the present invention is a method for managing and interacting with a referral network that allows users to refer businesses or consumers who might be in need of business funding, personal or consumer funding, as well as various goods and services.

### BACKGROUND OF THE INVENTION

The preferred embodiment of the present invention, the method for networking users for submission and processing of referrals, may be referred to hereinafter as “SIZL”. The present invention is a method that enables users to submit and track referral submissions that are routed to the proper service provider, based on internal data that is collected through a data acquisition process. This proprietary system protects users and manifests a more efficient process for the users and referral sources to procure a referred or request product or service. The present invention is a method for generating compensation by sending and receiving referrals. Additionally, the present invention builds a network of business, individual users, and consumer lenders. This network is accessible to all consumers, and professionals who create a user account through the method of the present invention. The present invention allows users to refer businesses or consumers who might be in need of business funding, personal/consumer funding, or a variety of goods and services. The present invention allows the most non-financially versed person to monetize accessible information and refer that data to the network of specialized business, consumer lenders, merchants, and consumer service providers for referral commissions. Thus, enabling the referralee to be provided with a desired service.

The present invention takes referrals to a new level, the ease of use to submit the information is second to none. The average time to submit a referral lead is 39 seconds, and allows the user to generate compensation with every submission. The referral commission structure is very attractive and highly lucrative. The consumer network created by the method of the present invention functions as a straightforward means for submitting referrals and receiving compensation for said referrals. Additionally, the method of the present invention makes use of multiple referral-acquisition processes. Specifically, the method of the present invention enables users to refer a business customer, refer personal customers, refer themselves, and refer their social/business network. The present invention is designed to implement a highly scalable network. Additionally, the present invention provides the requisite data to service providers to create notices of intent to borrow or buy a product or service.

### BRIEF DESCRIPTION OF THE DRAWINGS

FIG. 1 is a block diagram illustrating the system overview of the present invention.

FIG. 2 is a flowchart describing the overall process followed by the method of the present invention.

FIG. 3 is a flowchart describing a sub-process for selecting a desired referral-acquisition process using the method of the present invention.

FIG. 4 is a flowchart describing a sub-process for executing a visual-data-acquisition process using the method of the present invention.

FIG. 5 is a flowchart describing a sub-process for executing a personal-referral-acquisition process to submit a single referral using the method of the present invention.

FIG. 6 is a flowchart describing a sub-process for executing a personal-referral-acquisition process to submit a plurality of referrals using the method of the present invention.

FIG. 7 is a flowchart describing a sub-process for executing a business-referral-acquisition process to submit a single business referral using the method of the present invention.

FIG. 8 is a flowchart describing a sub-process for executing a business-referral-acquisition process to submit a plurality of business referrals using the method of the present invention.

FIG. 9 is a flowchart describing a sub-process for identifying referral-related pieces of information in visual referral data using the method of the present invention.

FIG. 10 is a flowchart describing a sub-process for identifying referral-related pieces of information in visual referral data when the visual data includes a receipt using the method of the present invention.

FIG. 11 is a flowchart describing a sub-process for identifying referral-related pieces of information in visual referral data when the visual data includes a picture of a place of business using the method of the present invention.

FIG. 12 is a flowchart describing a sub-process for identifying referral-related pieces of information in textual referral data using the method of the present invention.

FIG. 13 is a flowchart describing a sub-process for identifying a business account that is capable of providing a desired service using the method of the present invention.

FIG. 14 is a flowchart describing a sub-process for executing a service-contracting process between the referralee and the matching business account using the method of the present invention.

### DETAIL DESCRIPTIONS OF THE INVENTION

All illustrations of the drawings are for the purpose of describing selected versions of the present invention and are not intended to limit the scope of the present invention.

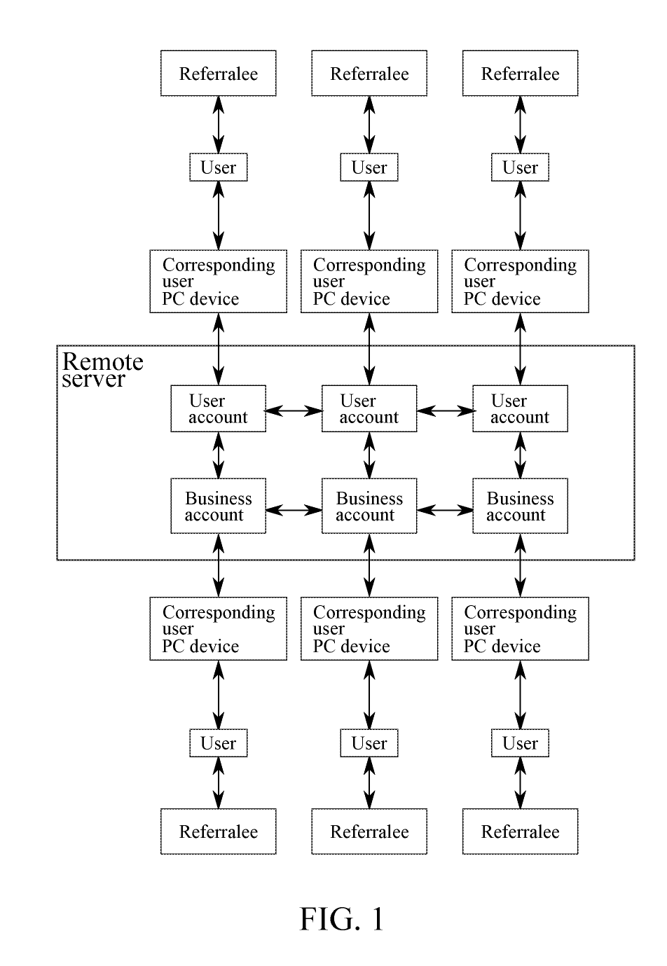

Rereferring to FIG. 1 through FIG. 14, the preferred embodiment of the present invention, the method for networking users for submission and processing of referrals, is a method that enables a user to generate compensation by referring others for products and services. That is, the present invention enables the user to share information about a referralee with other users in an effort to find a user who is capable of providing a desired good or service. The term “user” is used herein to refer to entities who are registered to send and receive referral information using the method of the present invention. Additionally, the term “user” is used herein to refer to various entities including, but not limited to, nonprofessional or independent individuals, professional individuals, businesses, and service providers. The term “referralee” is used herein to refer to entities whose business or personal information forms the subject of a referral. That is, the referralee is an entity who is being referred to a user for the purpose of having a desired good or service provided. The method of the present invention can be used to refer individuals who do not have user accounts as well as users who are seeking a desired product or service. Thus, users can become referralees when appropriate. Another aspect of the method of the present invention is to create a network of compensation-generating users. The user is able to leverage the aforementioned network to satisfy the disparate service requests of any referralee with which the user comes into contact. The method of the present invention enables this by performing dynamic processing and routing of referrals; such that, the user need only include information about the referralee in a referral and to use the method of the present invention to find other users capable of providing any goods and services for which the referralee is desirous. Additionally, the user is compensated for making a referral through the method of the present invention. As a result, the user is incentivized to submit referrals, and the referralee is connected with service providers capable of satisfying a service request.

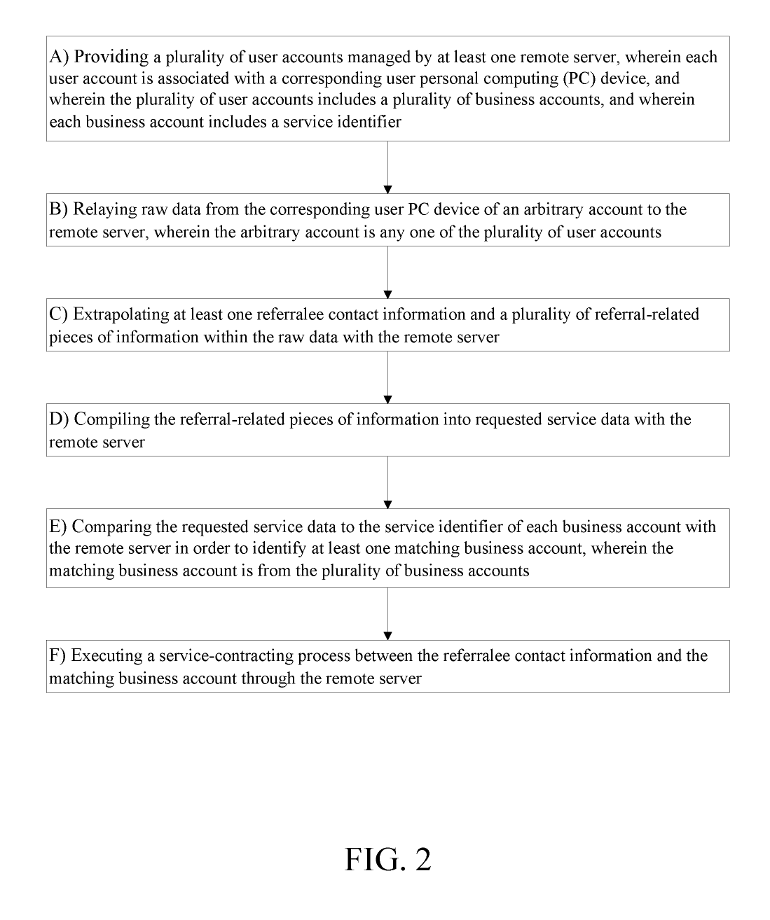

Rereferring to FIG. 1 and FIG. 2, the method of the present invention is executed on a system that links users in a network. Specifically, this is accomplished by providing a plurality of user accounts managed by at least one remote server (Step A). Each user account is a record that holds information about the user and grants the user access to employ the method of the present invention when sending and receiving referrals. Additionally, each user account is associated with a corresponding user personal computing (PC) device. The corresponding user PC device is any computing device that the user employs to send and receive referrals through the method of the present invention. Further, the group of computing devices that can be used as corresponding user PC devices includes, but is not limited to, laptop computers, desktop computers, smartphones, and tablet PCs. In the preferred embodiment of the present invention, the corresponding user PC device is a proprietary smartphone that is optimized to securely execute the method of the present invention. Additionally, the proprietary smartphone enables users to execute secure transactions through the method of the present invention. For example, the proprietary smartphone enables an auto mechanic to send a referral to the business accounts of financial institutions, wherein the referral is for a referralee who is seeking a loan. Once a business account agrees to provide the loan, the auto mechanic is able to use the proprietary smartphone to apply for the loan and to transfer the provided funds.

Rereferring to FIG. 2, the remote server is designed to perform the background processes required to dynamically process, pre-certify, and route referrals. Additionally, the remote server manages all communication between the plurality of user accounts, calculates appropriate compensation, and performs longitudinal analysis of the activity of each user account. As described above, some user accounts are associated with businesses. Accordingly, the plurality of user accounts includes a plurality of business accounts. Each business account includes a service identifier. The service identifier is a descriptive element found in each business account, and is used to denote the types of goods and services that the business account is capable of providing. For example, the business account for a financial institution will have a service identifier that denotes the business account as being capable of providing loans and finance-related products. The service identifier for the business account in this example will be different from the service identifier for a business account that is associated with a landscaping business.

Rereferring to FIG. 2, the overall method of the present invention enables the user to generate various types of referrals by transmitting both formatted and unformatted data to the remote server. To achieve this, the overall method of the present invention begins by relaying raw data from the corresponding user PC device of an arbitrary account to the remote server (Step B). The raw data contains referralee-related information. This can be information that is related to a single referralee or a group of referralees. Additionally, the raw data contains information that can be analyzed to determine the goods and services that the referralee desires. The arbitrary account is any one of the plurality of user accounts. As a result, every user is able to submit various types of referrals. The overall method continues by extrapolating at least one referralee contact information and a plurality of referral-related pieces of information from within the raw data with the remote server (Step C). The referralee contact information is a collection of personal information that relates to the referralee and provides a means of contacting the referralee. For example, the referralee contact information may include a name, a phone number, and an email address. The referral-related pieces of information comprise descriptions of the specific goods and services that the referralee requires. This information may be explicitly stated within the raw data, or the extrapolation process of Step C can be used to identify goods and services that will benefit the referralee. Consequently, Step C enables the overall method of the present invention to identify any important information that is included in the referral. In the preferred embodiment of the method of the present invention, the user is provided with a questionnaire or template that must be filled out when preparing the referral. As a result, the referral information is properly formatted to include all of the required referral information.

In a supplemental embodiment of the present invention, the extrapolation process of Step C includes a quality analysis and information verification sub-process. During this information verification sub-process, the referralee is sent a pre-processing message that contains a request to verify the referral related-pieces of information which were provided in the raw data. The referralee is then given the chance to correct any inaccuracies within the raw data. Additionally, the information verification sub-process is used to gather sensitive data that more accurately describes the referralee's position and desires. Specifically, the information verification sub-process functions as a data scrubbing routine that enables the referralee to provide greater detail about the desired service, while simultaneously enabling the method of the present invention to vet any provided data. By vetting the referral-related pieces of information prior to sending the requested service data to business accounts, the method of the present invention adds value to both business accounts and referralees. That is, the information verification process ensures that the business accounts are provided with accurate requested service data and that the referralee's desires are being appropriately represented.

Rereferring to FIG. 2, once the referralee contact information and the referral-related pieces of information are identified, the overall method continues by compiling the referral-related pieces of information into requested service data with the remote server (Step D). The requested service data contains formatted versions of the referral-related pieces of information which are used to dynamically route the referral to the appropriate users. This enables the overall method of the present invention to continue by comparing the requested service data to the service identifier of each business account with the remote server in order to identify at least one matching business account (Step E). The matching business account is the business account with a service identifier that indicates the business account will be capable of providing the service that the referralee desires. Specifically Step E enables the overall method of the present invention to identify the business accounts that are best suited to provide a desired service.

Additionally, the overall method of the present invention selects the most appropriate business accounts by factoring the referral-related pieces of information into the comparison process of Step E. The overall method continues by executing a service-contracting process between the referralee contact information and the matching business account through the remote server (Step F). The service-contracting process is a process that enables the matching business account and the referralee to communicate and come to an agreement about the services that will be provided in response to the referral. Additionally, Step F is used to determine any additional compensation that will be provided to the user who submitted the raw data, the referrer. Further, status updates are provided to the referrer, the referralee, and the matching business account during the service-contracting process.

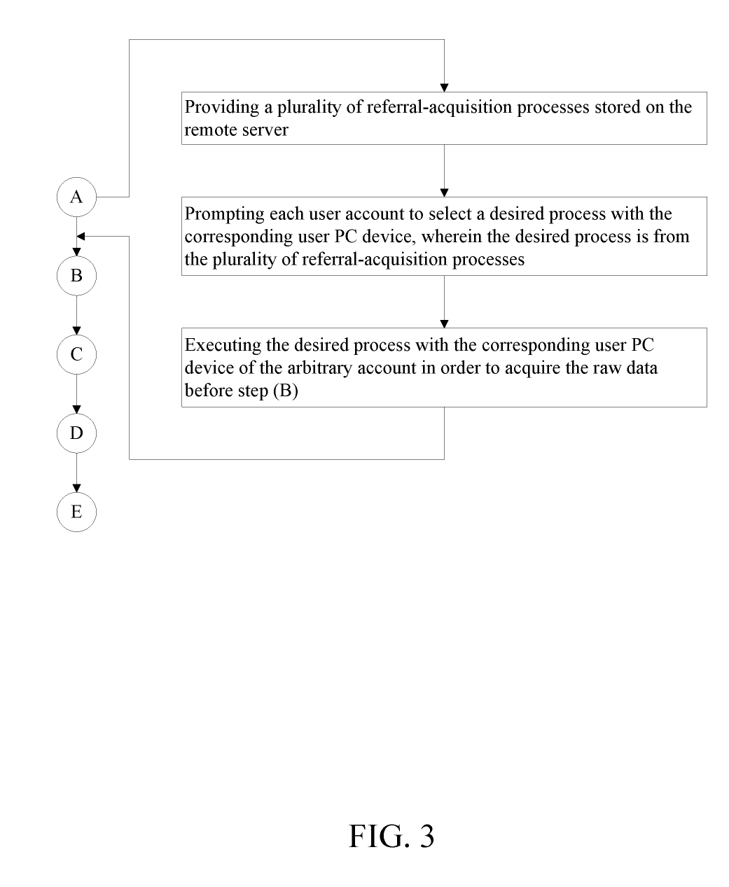

Rereferring to FIG. 3, as described above, the overall method of the present invention is designed to enable the user to submit various types of referrals. As such, the system for executing the method of the present invention provides a plurality of referral-acquisition processes stored on the remote server. Each of the referral-acquisition processes is a sub-process that is designed to enable the user to submit a specific type of referral. For example, the user is able to submit pictures that contain pieces of referral-related information. The user is also given the opportunity to submit referralee information that is entered into a text form, batches of referralee information, and business-account-to-business-account referrals. The method of the present invention includes a sub-process that enables the user to select the type of referral to be submitted. This sub-process begins by prompting each user account to select a desired process with the corresponding user PC device. The desired process is one of the referral-acquisition processes that the user will use to submit the referral. The sub-process continues by executing the desired process with the corresponding user PC device of the arbitrary account in order to acquire the raw data before Step B. Accordingly, once the user has selected the desired process, the method of the present invention executes the steps required to enable the user to submit a specific referral type.

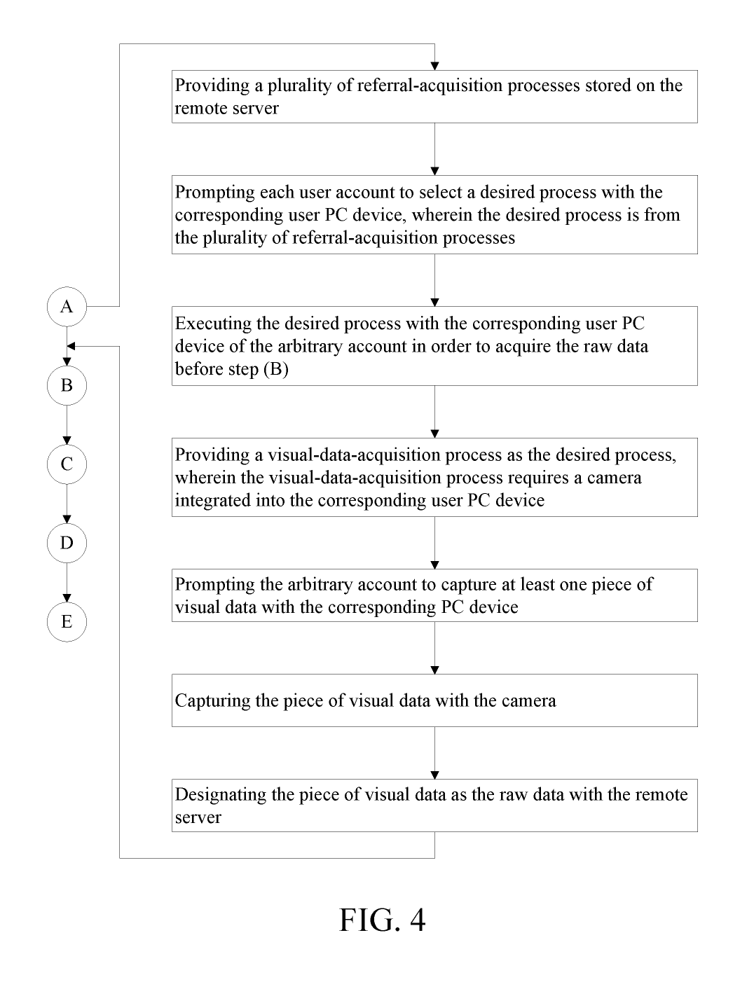

Rereferring to FIG. 4, the method of the present invention includes a sub-process that enables the user to submit pictures of receipts and other visual data as the referral. To initiate this process, the user selects a visual-data-acquisition process as the desired process. The user is able to execute this sub-process in real-time by using a corresponding user PC device that is equipped with a camera. Alternatively, the user may upload pictures that were taken at an earlier date through the corresponding user PC device. The sub-process begins by prompting the arbitrary account to capture at least one piece of visual data with the corresponding user PC device. The piece of visual data can be a picture or a video of information that the user can acquire while within a business establishment. The sub-process continues by capturing the piece of visual data with the camera. In the preferred embodiment of the visual-data-acquisition process, the user is prompted to take a picture of a receipt, at least one picture of a point of sale or card reader terminal, and at least one picture of the interior of the business establishment. The pictures that the user takes are classified as the pieces of visual data. Finally, the sub-process concludes by designating the piece of visual data as the raw data with the remote server. Thus, the piece of visual data is transferred to the remote server for further processing.

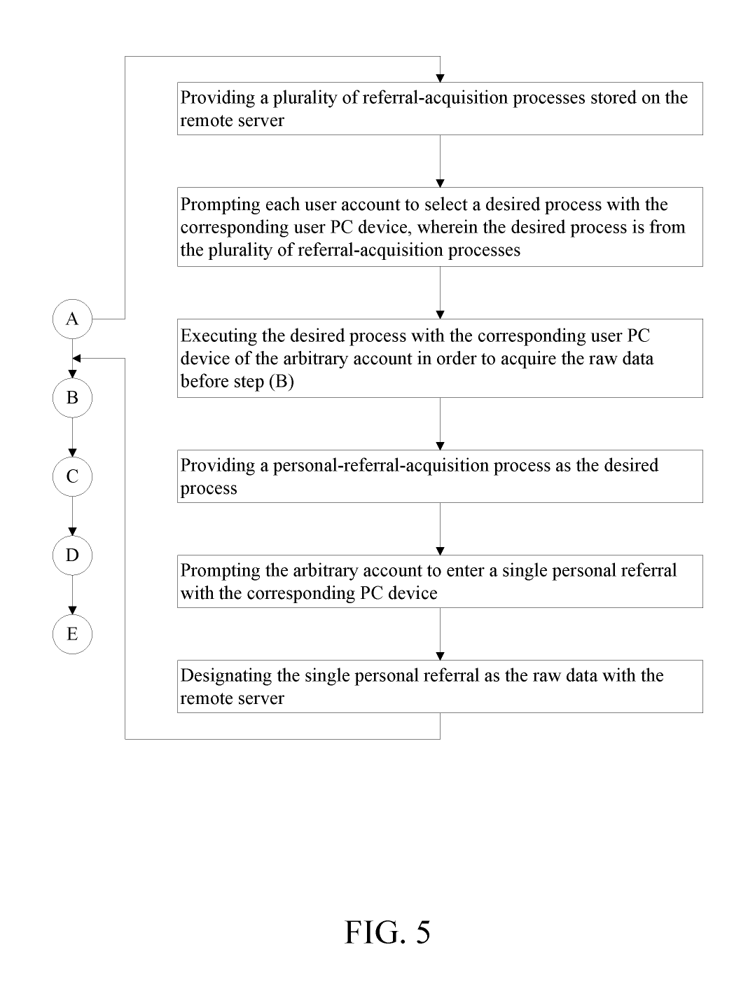

Rereferring to FIG. 5, the method of the present invention includes a sub-process that enables the user to submit a single referralee's information as the referral. To initiate this process, the user selects a personal-referral-acquisition process as the desired process. The personal-referral-acquisition process enables the user to refer a single referralee through the method of the present invention. The sub-process begins by prompting the arbitrary account to enter a single personal referral with the corresponding user PC device. The single personal referral is a referral that contains information which is directed toward the needs of a single referralee. While preparing the single personal referral, the user is given the opportunity to rate the referral in terms of possible success. Alternatively, the single personal referral can be used to designate a referralee who is interested in using the method of the present invention to send and receive referrals. Accordingly, the requested service data that is extrapolated during Step C will be a request for an invitation to create a new user account. The invitation to create the new user account will be transferred to the referralee after Step E. It is possible for the single personal referral to contain both a request for a desired service as well as a request for an invitation to create a new user account. The sub-process concludes by designating the single personal referral as the raw data with the remote server. Thus, the single personal referral is transferred to the remote server for further processing. Further, if a new user account is created as a result of the personal-referral-acquisition process, then that new user account will be forever tied to the user account that initiated the personal-referral-acquisition process. Consequently, the user will receive compensation for every successful referral that the new user account submits.

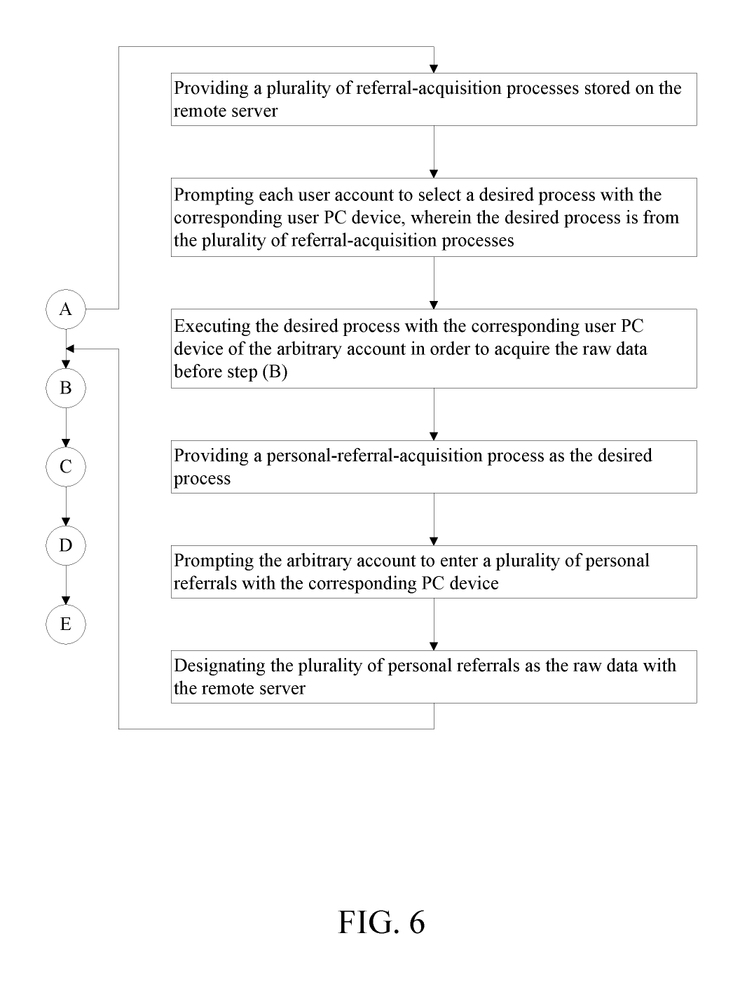

Rereferring to FIG. 6, the method of the present invention includes a sub-process that enables the user to submit a batch of referralee information as the referral. To initiate this process, the user selects the personal-referral-acquisition process as the desired process. The personal-referral-acquisition process enables the user to refer a plurality of referralees through the method of the present invention. The sub-process begins by prompting the arbitrary account to enter a plurality of personal referrals with the corresponding user PC device. Each of the plurality of personal referrals is a referral that contains information which is directed toward the needs of the plurality of referralees. The preferred embodiment of the personal-referral-acquisition process enables the user to import batches of referralee-related information from external sources, such as social media platforms and third-party databases. This functionality can be used to automatically refer large groups of referralees without entering unique pieces of referral related pieces of information for each referralee. Alternatively, the plurality of personal referrals can be used to designate multiple referralees who are interested in using the method of the present invention to send and receive referrals. Accordingly, the requested service data that is extrapolated during Step C will include multiple requests for invitations to create new user accounts. The invitation to create each new user account will be transferred to each of the plurality of referralees after Step E. It is possible for each of the plurality of personal referrals to contain both a request for a desired service as well as a request for an invitation to create a new user account. The sub-process concludes by designating the plurality of personal referrals as the raw data with the remote server. Thus, the plurality of personal referrals is transferred to the remote server for further processing. Further, if a new user account is created as a result of the personal-referral-acquisition process, then that new user account will be forever tied to the user account that initiated the personal-referral-acquisition process. Consequently, the user will receive compensation for every successful referral that the new user account submits.

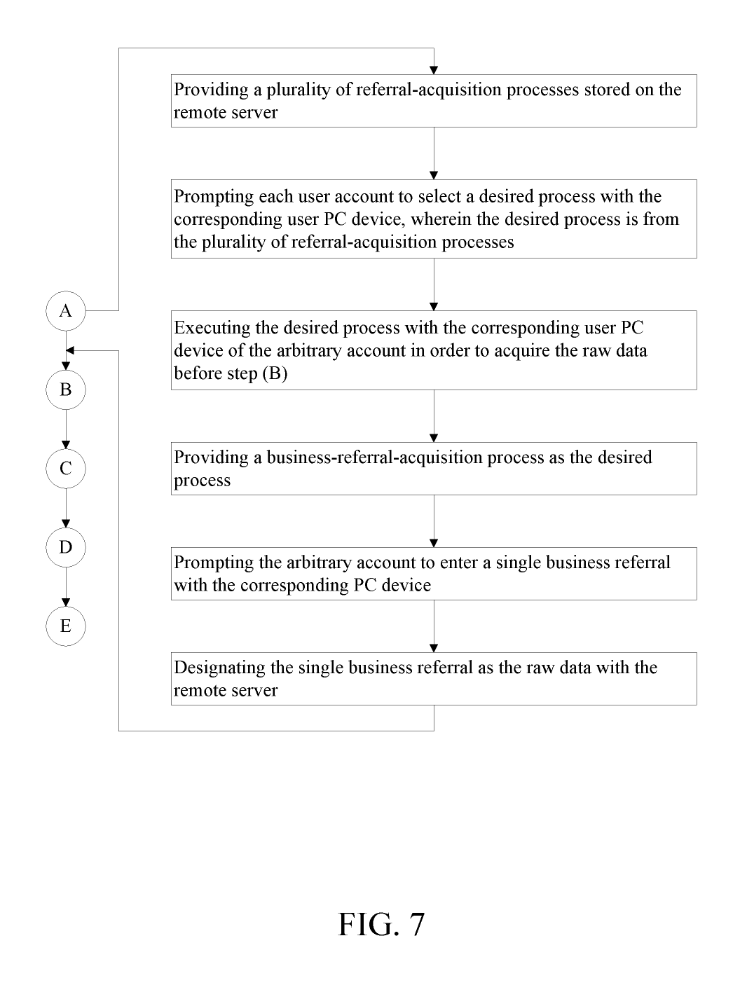

Rereferring to FIG. 7, the method of the present invention includes a sub-process that enables the user to submit information about a business account as the referral. To initiate this process, the user selects a business-referral-acquisition process as the desired process. The business-referral-acquisition process enables the user to designate a desired business account as the referralee through the method of the present invention. The sub-process begins by prompting the arbitrary account to enter a single business referral with the corresponding user PC device. The single business referral is a referral that contains information which is directed toward the needs of a single business account. While preparing the single business referral, the user is given the opportunity to rate the referral in terms of possible success, and to fill out a questionnaire that requests specific pieces of referral-related information. Alternatively, the single business referral can be used to designate a referralee who is interested in using the method of the present invention to send and receive referrals. Accordingly, the requested service data that is extrapolated during Step C will include a request for an invitation to create a new business account. The invitation to create the new business account will be transferred to the referralee after Step E. It is possible for the single business referral to contain both a request for a desired service as well as a request for the invitation to create a new business account. The sub-process concludes by designating the single business referral as the raw data with the remote server. Thus, the single personal referral is transferred to the remote server for further processing. Further, if a new business account is created as a result of the business-referral-acquisition process, then that new business account will be forever tied to the user account that initiated the business-referral-acquisition process. Consequently, the user will receive compensation for every successful referral that the new business account submits.

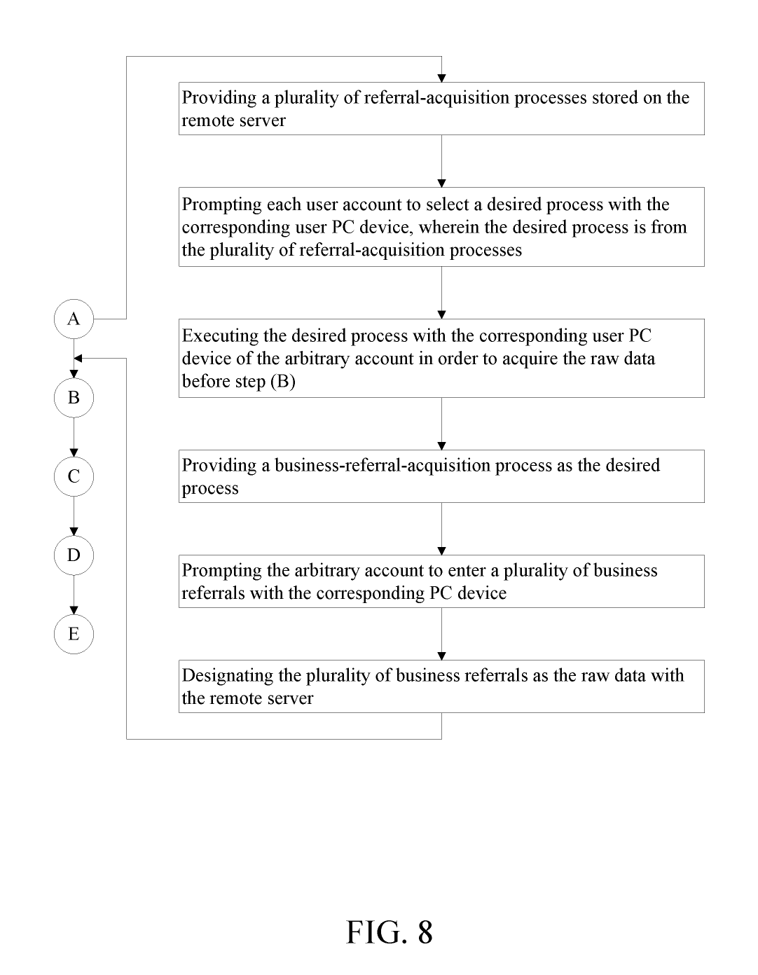

Rereferring to FIG. 8, the method of the present invention includes a sub-process that enables the user to submit information about a batch of business referralees as the referral. To initiate this process, the user selects the business-referral-acquisition process as the desired process. The business-referral-acquisition process enables the user to refer a plurality of businesses through the method of the present invention. The sub-process begins by prompting the arbitrary account to enter a plurality of business referrals with the corresponding user PC device. Each of the plurality of business referrals is a referral that contains information which is directed toward the needs of the plurality of business referralees. The preferred embodiment of the personal-referral-acquisition process enables the user to import batches of referralee-related information from external sources, such as social media platforms and third-party databases. This functionality can be used to automatically refer large groups of business referralees without entering unique pieces of referral related pieces of information for each business referralee. While preparing the plurality of business referrals, the user is given the opportunity to rate each referral in terms of possible success, and to fill out a questionnaire that requests specific pieces of referral-related information. Alternatively, the plurality of business referrals can be used to designate multiple referralees who are interested in using the method of the present invention to send and receive referrals. Accordingly, the requested service data that is extrapolated during Step C will include multiple requests for invitations to create new business accounts. The invitation to create each new business account will be transferred to each of the plurality of business referralees after Step E. It is possible for each of the plurality of business referrals to contain both a request for a desired service as well as a request for an invitation to create a new business account. The sub-process concludes by designating the plurality of business referrals as the raw data with the remote server. Thus, the plurality of business referrals is transferred to the remote server for further processing. Further, if a new business account is created as a result of the business-referral-acquisition process, then that new business account will be forever tied to the user account that initiated the business-referral-acquisition process. Consequently, the user will receive compensation for every referral that the new business account submits.

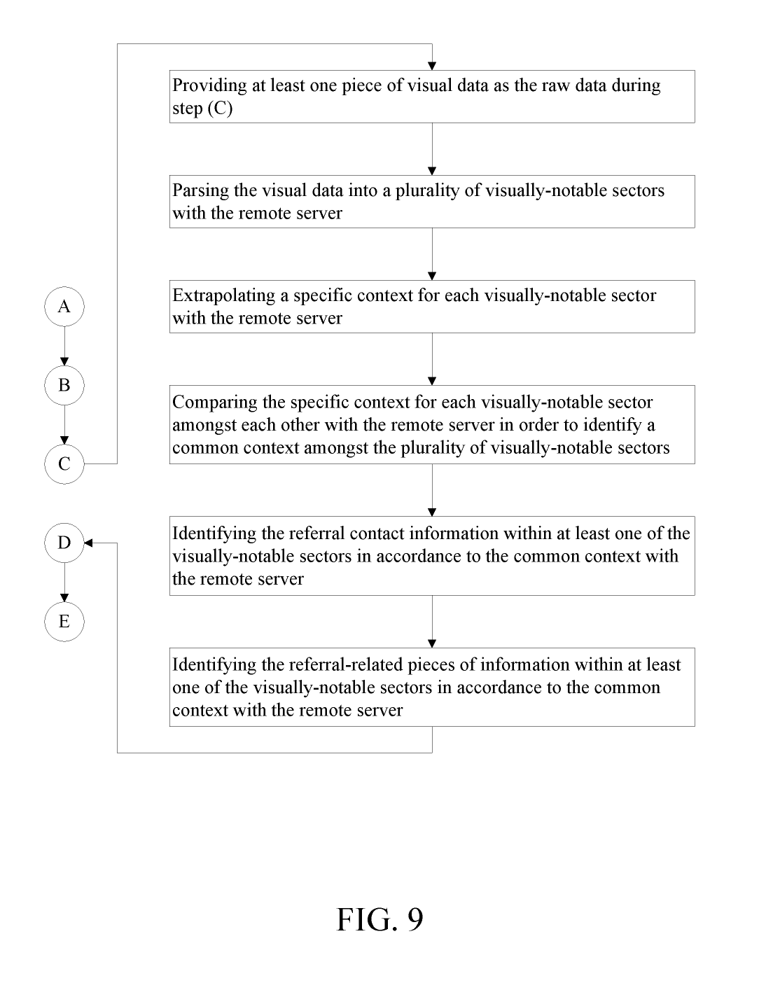

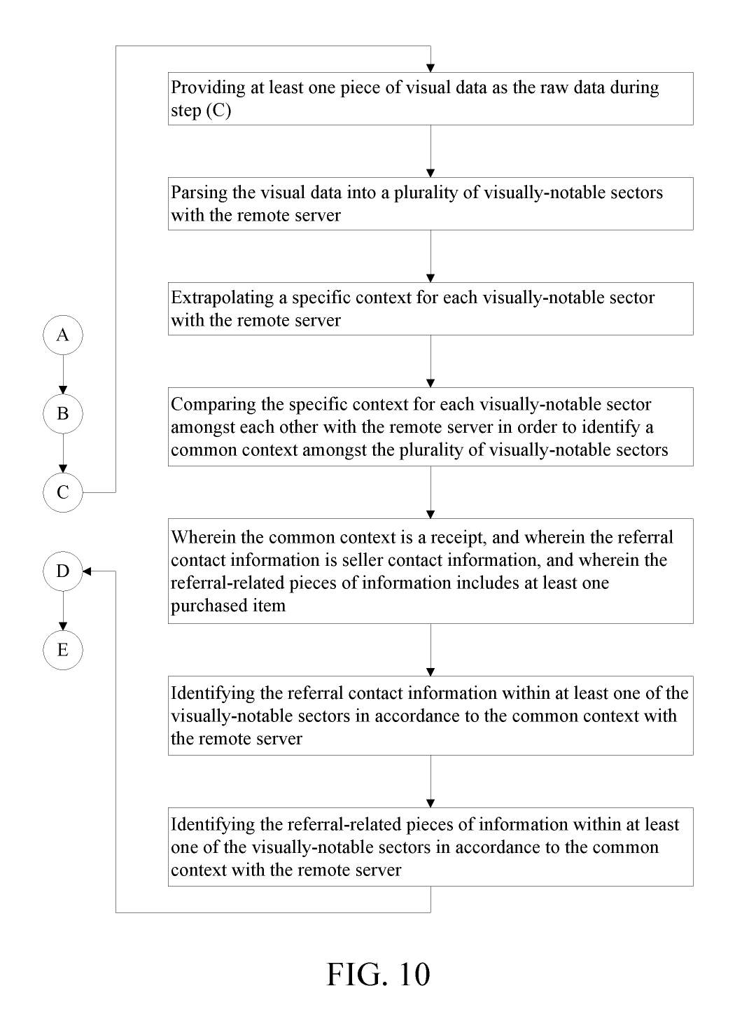

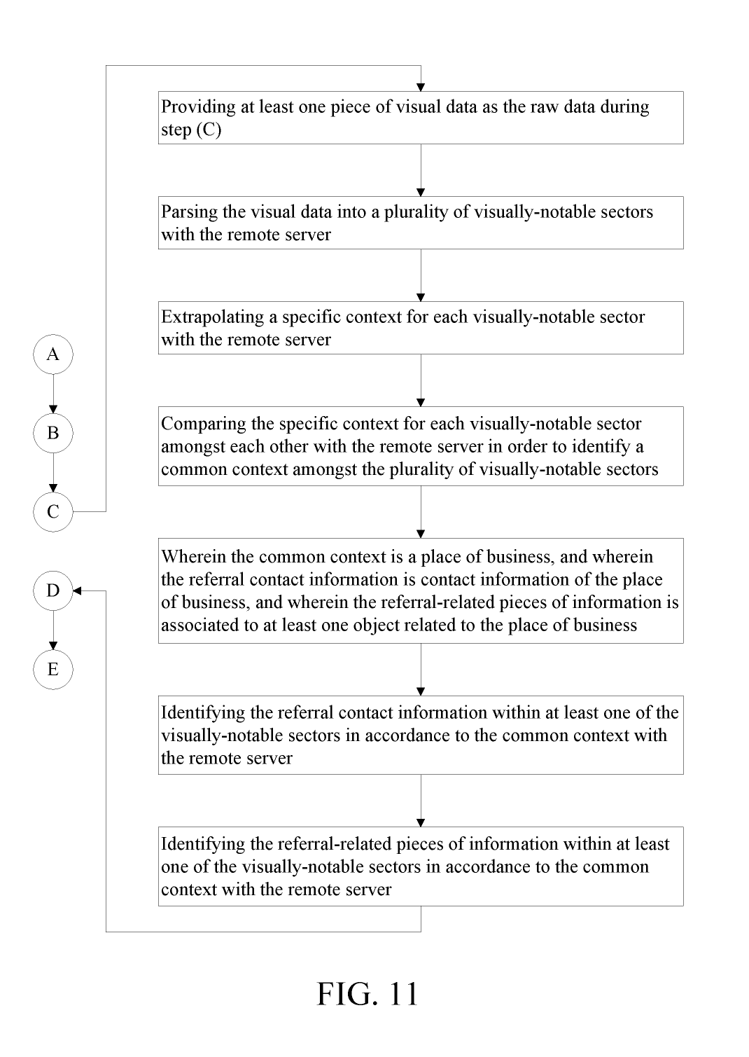

Rereferring to FIG. 9, FIG. 10, and FIG. 11, the method of the present invention includes a sub-process to perform the background processes required to extrapolate pieces of referral-relevant information from the piece of visual data that was transferred to the remote server as the raw data. This sub-process employs various computer vision techniques to identify and extract usable data from photographs and videos. This sub-process begins by parsing the visual data into a plurality of visually-notable sectors with the remote server. The visually-notable sectors are areas of interest within the visual data that are identified a preprocessing phase of the extrapolation process. The sub-process continues by extrapolating a specific context for each visually-notable sector with the remote server. The specific context is a designation that the sub-process attaches to each visually-notable sector. This enables the sub-process to categorize each visually-notable sector in terms of what information is contained within each sector. The sub-process continues by comparing the specific context for each visually-notable sector amongst each other with the remote server in order to identify a common context amongst the plurality of visually-notable sectors. The common context is a specific context that is found within a group of visually-notable sectors. Thus identified, the sub-process is able to stitch together groups of visually-notable sectors that form a single object or area of interest within a photograph or video. For example, if the user submits a photograph of a receipt as the raw data, the preceding steps of the sub-process can be used to differentiate the list of items purchased from any printed contact information. The sub-process continues by identifying the referral contact information within at least one of the visually-notable sectors in accordance to the common context with the remote server. Further, the sub-process continues by identifying the referral-related pieces of information within at least one of the visually-notable sectors in accordance to the common context with the remote server. In the above-described example, the common context is a receipt, and the referral contact information is seller contact information. Additionally, the referral-related pieces of information includes at least one purchased item and a date of the transaction. In a separate example, the user supplies a picture of the interior or exterior of a place of business. In this example, the common context is a place of business, and the referral contact information is contact information of the place of business. Additionally, the referral-related pieces of information is associated to at least one object related to the place of business. For example, if the user takes a picture of the shelving units within the place of business, the object that is related to the place of business will be the shelving units. The sub process will then identify defects in the shelving units and identify business accounts that provide shelving units. The method of the present invention will then provide offers to the place of business for new or improved shelving units.

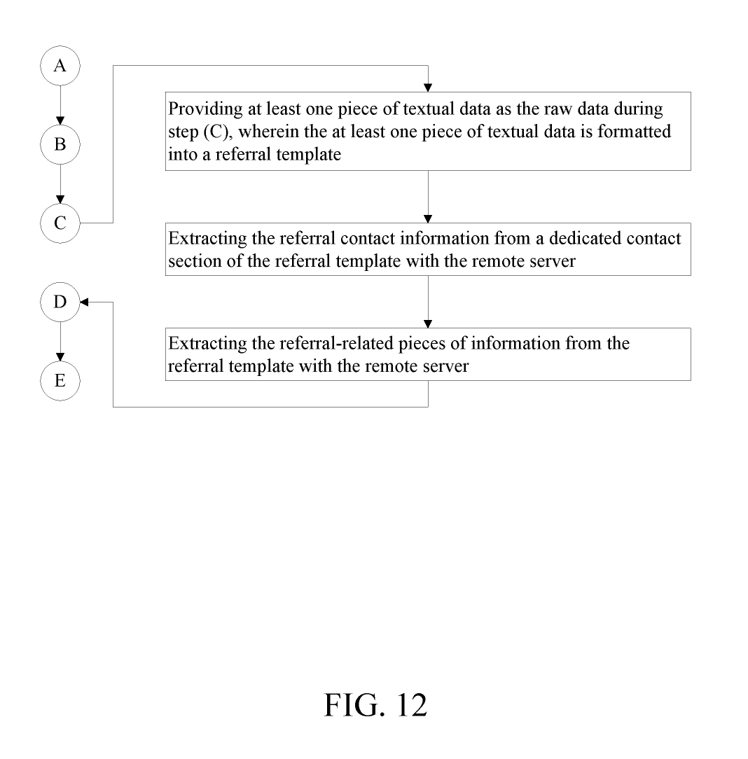

Rereferring to FIG. 12, the method of the present invention includes a sub-process to perform the background processes required to extrapolate pieces of referral-relevant information from textual data that was transferred to the remote server as the raw data. Specifically, the textual data is in the form of a referral template that contains the referral contact information and the referral-related pieces of information which were gathered during Step C. This referral template is filled out by answering a questionnaire during the referral-acquisition process. The sub-process begins by extracting the referral contact information from a dedicated contact section of the referral template with the remote server. The sub-process continues by extracting the referral-related pieces of information from the referral template with the remote server. Accordingly, the method of the present invention is able to parse referrals that are submitted as textual data and identify the information required to identify the referralee contact information as well as the pieces of information that identify the desired service.

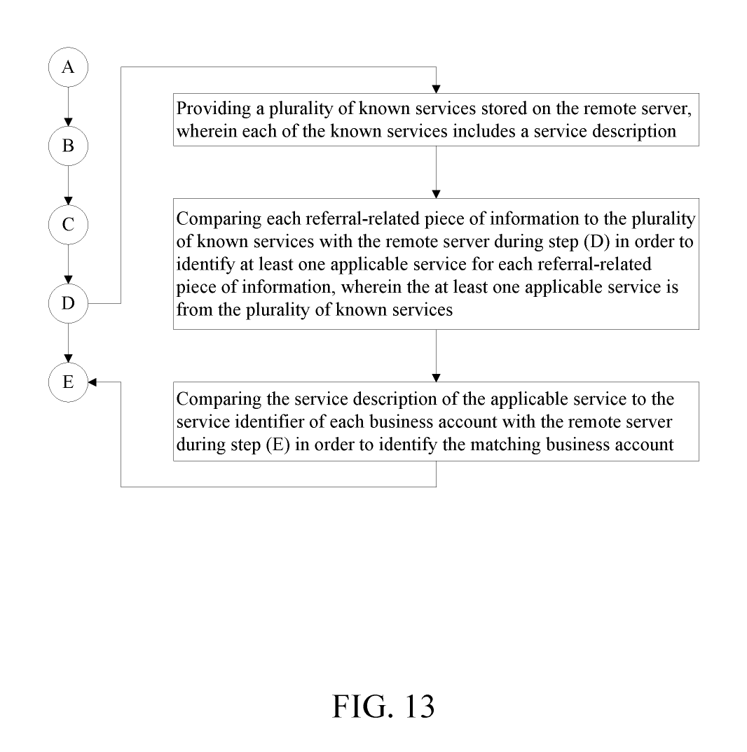

Rereferring to FIG. 13, the method of the present invention includes a sub-process for determining the desired service in the referral as well as determining the business accounts that will best be able to provide the desired service. To facilitate this, the system required to execute the method of the present invention provides a plurality of known services stored on the remote server. Each of the known services is a service that can be provided by at least one business account. Thus, each known service includes a service description that outlines the parameters of what can and cannot be performed by the available business accounts. The sub-process begins by comparing each referral-related piece of information to the plurality of known services with the remote server during Step D in order to identify at least one applicable service for each referral-related piece of information. The applicable service is one of the plurality of known services. Consequently, the sub-process is able to parse through the supplied referral-related piece of information to identify what services the referralee desires. This step is used to determine if the referralee, or group of referralees, wants to receive an invitation to create a new user or business account. Alternatively, this step is used to determine if the referralee, or group of referralees, wants to have a specific service provided e.g. the referralee is seeking a loan. The sub-process continues by comparing the service description of the applicable service to the service identifier of each business account with the remote server during step (E) in order to identify the matching business account. The sub-process then identifies the business accounts that are able to provide the desired service.

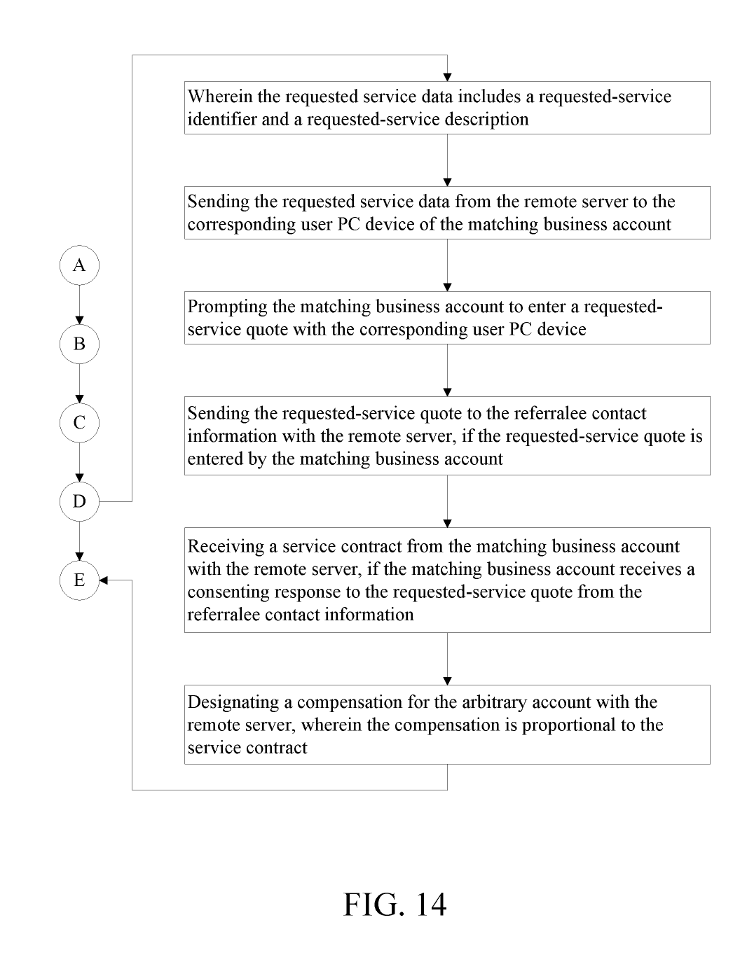

Rereferring to FIG. 14, once the appropriate matching business account is identified, the method of the present invention proceeds to executing a service-contracting sub-process. The service-contracting process enables the matching business account and the referralee to work out the terms of the desired service. The sub-process begins by sending the requested service data from the remote server to the corresponding user PC device of the matching business account. The requested service data contains information that identifies the referralee and the scope of the desired service. The matching business account is then provided with the information required to generate a quote for the price of providing the desired service. The sub-process continues by prompting the matching business account to enter a requested-service quote with the corresponding user PC device. The sub-process continues by sending the requested-service quote to the referralee contact information with the remote server, if the requested-service quote is entered by the matching business account. Once the requested-service quote is transferred to the referralee contact information, the matching business account and the referralee are able to work out a contract that defines the scope of work and the price to complete said work. The sub-process continues by receiving a service contract from the matching business account with the remote server, if the matching business account receives a consenting response to the requested-service quote from the referralee contact information. The matching business account then transmits the agreed upon contract to the remote server for processing. The sub-process continues by designating a compensation for the arbitrary account with the remote server. The compensation is a reward that will be provided to the user who made the original referral. Additionally, the compensation is proportional to the service contract. That is, the user may receive a percentage of the price that was agreed upon in the service contract. Alternatively, the user may receive compensation that is not monetary in nature.

The preferred embodiment of the method of the present invention is used to track user activity, so as to construct a digital profile of the user and better provide compensation and services. Specifically, the data that is transmitted by the user during the visual-data-acquisition process is used to identify patterns and trends in the user's behavior. This tracked data enables the method of the present invention to generate offers and incentives that are tailored to the user. This tracked data can be accessed by the user to gain a better understanding of spending habits or referral data. Furthermore, the method of the present invention enables the user to view reports that detail their referral history and the compensation generated by their referrals and referralees.

Although the invention has been explained in relation to its preferred embodiment, it is to be understood that many other possible modifications and variations can be made without departing from the spirit and scope of the invention as hereinafter claimed.

What is claimed is:

1. A method for networking users for submission and processing of referrals, the method comprises the steps of:
(A) providing a plurality of user accounts managed by at least one remote server, wherein each user account is associated with a corresponding user personal computing (PC) device, and wherein the plurality of user accounts includes a plurality of business accounts, and wherein each business account includes a service identifier;
(B) relaying raw data from the corresponding user PC device of an arbitrary account to the remote server, wherein the arbitrary account is any one of the plurality of user accounts;
(C) extrapolating at least one referralee contact information and a plurality of referral-related pieces of information from within the raw data with the remote server;
(D) compiling the referral-related pieces of information into requested service data with the remote server;
(E) comparing the requested service data to the service identifier of each business account with the remote server in order to identify at least one matching business account, wherein the matching business account is from the plurality of business accounts;
(F) executing a service-contracting process between the referralee contact information and the matching business account through the remote server;

2. The method for networking users for submission and processing of referrals, the method as claimed in claim 1 comprises the steps of:
providing a plurality of referral-acquisition processes stored on the remote server;
prompting each user account to select a desired process with the corresponding user PC device, wherein the desired process is from the plurality of referral-acquisition processes;
executing the desired process with the corresponding user PC device of the arbitrary account in order to acquire the raw data before step (B);

3. The method for networking users for submission and processing of referrals, the method as claimed in claim 2 comprises the steps of:
providing a visual-data-acquisition process as the desired process, wherein the visual-data-acquisition process requires a camera integrated into the corresponding user PC device;
prompting the arbitrary account to capture at least one piece of visual data with the corresponding user PC device;
capturing the piece of visual data with the camera;
designating the piece of visual data as the raw data with the remote server;

4. The method for networking users for submission and processing of referrals, the method as claimed in claim 2 comprises the steps of:
providing a personal-referral-acquisition process as the desired process;
prompting the arbitrary account to enter a single personal referral with the corresponding user PC device;
designating the single personal referral as the raw data with the remote server;

5. The method for networking users for submission and processing of referrals, the method as claimed in claim 2 comprises the steps of:
providing a personal-referral-acquisition process as the desired process;
prompting the arbitrary account to enter a plurality of personal referrals with the corresponding user PC device;
designating the plurality of personal referrals as the raw data with the remote server;

6. The method for networking users for submission and processing of referrals, the method as claimed in claim 2 comprises the steps of:
providing a business-referral-acquisition process as the desired process;
prompting the arbitrary account to enter a single business referral with the corresponding user PC device;
designating the single business referral as the raw data with the remote server;

7. The method for networking users for submission and processing of referrals, the method as claimed in claim 2 comprises the steps of:
providing a business-referral-acquisition process as the desired process;
prompting the arbitrary account to enter a plurality of business referrals with the corresponding user PC device;
designating the plurality of business referrals as the raw data with the remote server;

8. The method for networking users for submission and processing of referrals, the method as claimed in claim 1 comprises the steps of:
providing at least one piece of visual data as the raw data during step (C);
parsing the visual data into a plurality of visually-notable sectors with the remote server;
extrapolating a specific context for each visually-notable sector with the remote server;
comparing the specific context for each visually-notable sector amongst each other with the remote server in order to identify a common context amongst the plurality of visually-notable sectors;
identifying the referral contact information within at least one of the visually-notable sectors in accordance to the common context with the remote server;
identifying the referral-related pieces of information within at least one of the visually-notable sectors in accordance to the common context with the remote server;

9. The method for networking users for submission and processing of referrals, the method as claimed in claim 8, wherein the common context is a receipt, and wherein the referral contact information is seller contact information, and wherein the referral-related pieces of information includes at least one purchased item;

10. The method for networking users for submission and processing of referrals, the method as claimed in claim 8, wherein the common context is a place of business, and wherein the referral contact information is contact information of the place of business, and wherein the referral-related pieces of information is associated to at least one object related to the place of business;

11. The method for networking users for submission and processing of referrals, the method as claimed in claim 1 comprises the steps of:
providing at least one piece of textual data as the raw data during step (C), wherein the at least one piece of textual data is formatted into a referral template;
extracting the referral contact information from a dedicated contact section of the referral template with the remote server;
extracting the referral-related pieces of information from the referral template with the remote server;

12. The method for networking users for submission and processing of referrals, the method as claimed in claim 1 comprises the steps of:
providing a plurality of known services stored on the remote server, wherein each of the known services includes a service description;
comparing each referral-related piece of information to the plurality of known services with the remote server during step (D) in order to identify at least one applicable service for each referral-related piece of information, wherein the at least one applicable service is from the plurality of known services;
comparing the service description of the applicable service to the service identifier of each business account with the remote server during step (E) in order to identify the matching business account;

13. The method for networking users for submission and processing of referrals, the method as claimed in claim 1 comprises the steps of:
wherein the requested service data includes a requested-service identifier and a requested-service description;
sending the requested service data from the remote server to the corresponding user PC device of the matching business account;
prompting the matching business account to enter a requested-service quote with the corresponding user PC device;
sending the requested-service quote to the referralee contact information with the remote server, if the requested-service quote is entered by the matching business account;
receiving a service contract from the matching business account with the remote server, if the matching business account receives a consenting response to the requested-service quote from the referralee contact information;
designating a compensation for the arbitrary account with the remote server, wherein the compensation is proportional to the service contract;
